(19) United States
(12) Patent Application Publication
(10) Pub. No.: US 2025/0286249 A1
(43) Pub. Date: Sep. 11, 2025

(54) SECONDARY BATTERY

(71) Applicant: Samsung SDI Co., Ltd., Yongin-si (KR)

(72) Inventors: Hyun Ki JUNG, Yongin-si (KR); Sung Gwi KO, Yongin-si (KR); Gun Gue PARK, Yongin-si (KR); Myung Seob KIM, Yongin-si (KR); Woo Tae JUN, Yongin-si (KR); Yoon Sun YOO, Yongin-si (KR); Gwan Hyeon YU, Yongin-si (KR); Ho Jae LEE, Yongin-si (KR); Mun Sung KIM, Yongin-si (KR)

(21) Appl. No.: 18/773,305

(22) Filed: Jul. 15, 2024

(30) Foreign Application Priority Data
Mar. 11, 2024 (KR) 10-2024-0033609

(51) Int. Cl. H01M 50/559; H01M 50/107; H01M 50/586

(52) U.S. Cl. CPC H01M 50/559; H01M 50/107; H01M 50/586; H01M 2200/20

(57) ABSTRACT

A secondary battery configured to block a supply of current in response to a pressure within the secondary battery increasing. A secondary battery includes a cylindrical can accommodating an electrode assembly, a positive electrode current collector plate electrically connected to the electrode assembly and inside the cylindrical can, an inner terminal electrically connected to the positive electrode current collector plate and having a connection hole, a variable connection part fixed to the cylindrical can in contact with the inner terminal and spaced apart from the inner terminal to block a flow of current in response to an internal pressure of the cylindrical can increasing, a terminal cover electrically connected to the variable connection part and outside the cylindrical can, and a spacer between the variable connection part and the terminal cover and configured to define an inner space for movement of the variable connection part.

### CROSS-REFERENCE TO RELATED APPLICATION

The present application claims priority to and the benefit of Korean Application No. 10-2024-0033609, filed on Mar. 11, 2024, in the Korean Intellectual Property Office, the entire disclosure of which is incorporated herein by reference.

### BACKGROUND

### 1. Field

The present disclosure relates to a secondary battery.

### 2. Description of the Related Art

Unlike a primary battery that cannot be recharged, a secondary battery is a battery that can be recharged and discharged. A low-capacity secondary battery may be used for portable small-sized electronic devices, such as smartphones, feature phones, notebook computers, digital cameras, and camcorders, and a high-capacity secondary battery may be used as a power source for driving a motor and a power storage battery in hybrid vehicles or electric vehicles. The secondary battery may include an electrode assembly having a positive electrode and a negative electrode, a case accommodating the electrode assembly, an electrode terminal connected to the electrode assembly, and the like.

The above-described information disclosed in the technology that serves as the background of the present disclosure is only for improving understanding of the background of the present disclosure and thus may include information that does not constitute the related art.

### SUMMARY

Embodiments relate to a secondary battery that is configured to block a supply of current in response to a pressure inside the secondary battery increasing.

In addition, embodiments relate to a secondary battery that is configured to achieve or provide a stable welding area by increasing an area of the secondary battery that is in contact with a busbar.

These and other aspects and features of the present disclosure will be described in or will be apparent from the following description of embodiments of the present disclosure.

According to some embodiments, a secondary battery includes: a cylindrical can accommodating an electrode assembly; a positive electrode current collector plate electrically connected to the electrode assembly and inside the cylindrical can; an inner terminal electrically connected to the positive electrode current collector plate and including a connection hole; a variable connection part fixed to the cylindrical can in contact with the inner terminal and spaced apart from the inner terminal to block a flow of current in response to an internal pressure of the cylindrical can increasing; a terminal cover electrically connected to the variable connection part and outside the cylindrical can; and a spacer between the variable connection part and the terminal cover and configured to define an inner space for movement of the variable connection part.

An edge of the variable connection part may be fixed to the cylindrical can, and a center of the variable connection part may be in contact with the inner terminal.

The variable connection part may include: a fixed body inside the cylindrical the movement of which is restricted; and a variable body extending from the fixed body and fixed to the inner terminal and configured to move in a direction away from the inner terminal in response to a pressure of a gas passing through the inner terminal.

The variable connection part may further include: an extension body extending to the outside of the cylindrical can from the fixed body; and a bending body extending from the extension body and hung on the outside of the cylindrical can and electrically connected to the terminal cover.

The secondary battery may further include a first insulating member between the fixed body and the inner terminal and including an insulating material.

The secondary battery may further include a second insulating member between the variable connection part and the cylindrical can and including an insulating material.

The variable body may be fixed to the inner terminal by one or more welds.

A notch having a groove shape to induce deformation of the variable body may be provided in plurality in the variable body.

The secondary battery may further include: a first notch having a groove along a circumferential direction; and a second notch inside the first notch and having a groove along a circumferential direction.

The terminal cover may include: a terminal body in contact with and electrically connected to the variable connection part; and a terminal protrusion including a protrusion protruding from the terminal body to the spacer.

The spacer may be made of an insulating material.

The spacer may include: a spacer body between the terminal cover and the variable connection part and made of an insulating material; and a sidewall member extending from an edge of the spacer body to support the variable connection part.

According to some embodiments, a secondary battery includes: a cylindrical can accommodating an electrode assembly; an inner terminal electrically connected to the electrode assembly and including a connection hole; a variable connection part fixed to the cylindrical can and in contact with the inner terminal and configured to block a flow of current in response to an internal pressure of the cylindrical can increasing; and a terminal cover electrically connected to the variable connection part and outside the cylindrical can, wherein the variable connection part includes: a fixed body inside the cylindrical can the movement of which is restricted; and a variable body extending from the fixed body and fixed to the inner terminal and configured to move in a direction away from the inner terminal due to a pressure of a gas passing through the inner terminal.

The secondary battery may further include a positive electrode current collector plate between the electrode assembly and the inner terminal and electrically connected to the electrode assembly and the inner terminal.

The positive electrode current collector plate may include: a current collector body in contact with and electrically connected to the electrode assembly; an inner body inside a spaced hole at a center of the current collector body and fixed to the inner terminal; and a bridge configured to connect the current collector body to the inner body.

The inner terminal may include: an edge member between the positive electrode current collector plate and the variable connection part; a central body inside a connection hole disposed at a center of the edge member and electrically connected to the inner body and the variable body; and a connection body configured to connect the edge member to the central body.

The variable body may include a plurality of notches each having a groove shape configured to induce deformation of the variable body.

The secondary battery may further include a spacer between the variable connection part and the terminal cover, made of an insulating material, and configured to define an inner space for movement of the variable connection part.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIGS. 1 and 2 illustrate perspective and cross-sectional views of a secondary battery according to embodiments;

FIG. 3 illustrates an exploded perspective view of the secondary battery according to embodiments;

FIG. 4 illustrates a cross-sectional view of a state in which a variable connection part is in contact with an inner terminal according to embodiments;

FIG. 5 illustrates a cross-sectional view of a state in which the variable connection part is spaced apart from the inner terminal according to embodiments;

FIGS. 6A and 6B illustrate perspective views of a battery pack including the secondary battery according to embodiments; and

FIGS. 7A and 7B illustrate perspective and side views of a vehicle including the battery pack according to embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

In addition, the terms “comprise” or “include” and/or “comprising” or “including,” when used in this specification, specify the presence of stated shapes, numbers, steps, operations, members, elements, and/or groups thereof, but do not preclude the presence or addition of one or more other shapes, numbers, steps, operations, members, elements, and/or groups thereof.

Additionally, for the purpose of facilitating an understanding of the invention, the attached drawings are not depicted to actual scale; dimensions of some components may be exaggerated for clarity. Also, identical components in different embodiments may be denoted with the same reference numerals.

When two objects of comparison are referred to as being the same, it means the two objects are “substantially the same.” Thus, substantially the same may include a deviation that is considered low in the art, for example, a deviation of less than 5%. In addition, when a parameter is said to be uniform in a certain region, it may mean that the parameter is uniform from an average perspective.

Although “first,” “second,” and the like are used to describe various components, these components are of course not limited by these terms. These terms are only used to distinguish one component from other components, and unless otherwise stated, a first component could be termed a second component.

Throughout the specification, unless specifically stated otherwise, each component may be singular or plural.

When an arbitrary element is referred to as being “disposed above (or below)” or “disposed on (or under)” a component, it may mean not only that the arbitrary element is disposed in contact with an upper surface (or lower surface) of the component, but also that other elements may be interposed between the component and the arbitrary element disposed on (or under) the component.

When a component is described as being “connected,” “coupled,” or “joined” to another component within this patent document, it is understood that the components may be directly connected or joined to each other. However, it should also be interpreted that an intervening component may be interposed between them, or that each component may be “connected,” “coupled,” or “joined” through another intermediary component. Furthermore, when one part is described as being electrically connected (electrically coupled) to another, this encompasses not only a direct connection but also includes scenarios where other elements are positioned in between, facilitating an indirect connection.

Throughout this specification, the term ‘A and/or B’ should be interpreted as meaning either A, B, or both A and B, unless an alternative interpretation is explicitly stated. Thus, ‘and/or’ encompasses any and all possible combinations of the items listed. Similarly, when ‘C to D’ is mentioned, it is understood to mean C or more, up to and including D, unless noted otherwise. The terminology employed herein is intended solely for describing specific embodiments and should not be regarded as limiting the scope of this disclosure.

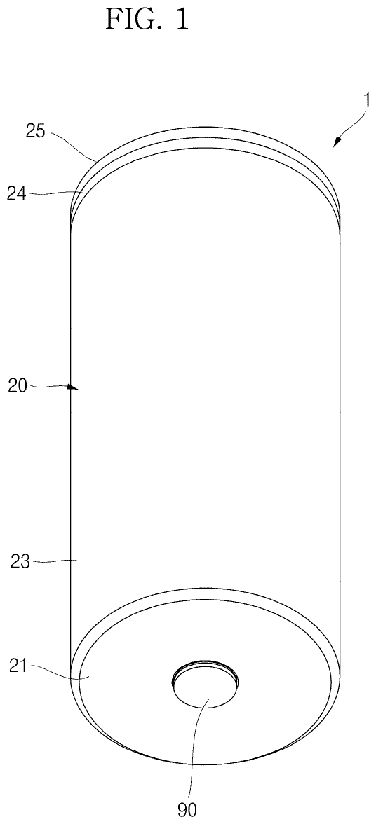

FIGS. 1 and 2 illustrate perspective and cross-sectional views, respectively, of a secondary battery 1 according to embodiments. As illustrated in FIGS. 1 and 2, a secondary battery 1 according to embodiments may include an electrode assembly 10, a cylindrical can 20, a cap plate 30, a negative electrode current collector plate 40, a positive electrode current collector plate 50, an inner terminal 60, a variable connection part 70, a spacer 80, and a terminal cover 90. In one or more embodiments, the secondary battery 1 may further include a first insulating member 100 and a second insulating member 110. In the present disclosure, the secondary battery 1 may be referred to as a cylindrical secondary battery 1 or a battery.

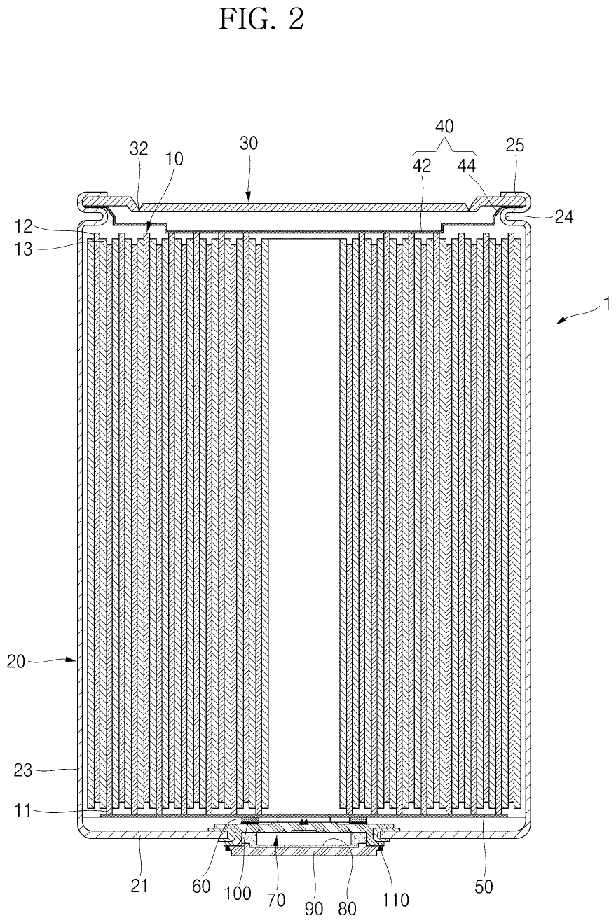

The cylindrical can 20 may accommodate the electrode assembly 10 and an electrolyte and may define an outer appearance of the secondary battery 1 together with the cap plate 30 and the terminal cover 90. In the present disclosure, the cylindrical can 20 may include or be referred to as a case, a can, a housing, or an exterior. The cylindrical can 20 may have any suitable shape for accommodating the electrode assembly 10 and including a terminal hole 22 (see FIG. 3) at one side and an opened inlet at the other side. The cylindrical can 20 may include a circular base part 21 and a side part 23 extending vertically from an edge (e.g., a peripheral or circumferential edge) of the base part 21. The base part 21 and the side part 23 of the cylindrical can 20 may be integral with each other.

The circular base part 21 may have a flat circular plate shape and may include the terminal hole 22 passing through a central portion (or substantially a central portion) of the circular base part 21. The variable connection part 70 may be accommodated in the terminal hole 22 of the base part 21.

A second insulating member 110 for sealing and electrical insulation may be between the terminal hole 22 and the variable connection part 70. The second insulating member 110 may block contact between the cylindrical can 20 and the variable connection part 70 to electrically separate or isolate the cylindrical can 20 from the variable connection part 70. The terminal hole 22 of the base part 21 may be sealed by the second insulating member 110 and the variable connection part 70. The second insulating member 110 and the first insulating member 100, which will be described later, may be made of a resin material such as polyethylene (PE), polypropylene (PP), or polyethylene terephthalate (PET).

During a process of manufacturing the secondary battery 1, an upper portion (based on the orientation of the secondary battery 1 depicted in FIG. 2) of the cylindrical can 20 may be open. Thus, during the process of manufacturing the secondary battery 1, the electrode assembly 10 may be inserted, together with the electrolyte, through the opened upper portion of the cylindrical can 20. The electrolyte and the electrode assembly 10 may be inserted into the cylindrical can 20 in a downward direction from the open upper portion of the cylindrical can 20. After the electrolyte and the electrode assembly 10 are inserted into the can 20 as described above, the cap plate 30 may be coupled to the open upper end to seal the inside of the cylindrical can 20.

In some embodiments, lithium ions may move between a positive electrode plate and a negative electrode plate of the electrode assembly 10. The electrolyte may be a non-aqueous organic electrolyte that is a mixture of lithium salt and a high-purity organic solvent. Furthermore, the electrolyte may be a polymer including a polymer electrolyte or a solid electrolyte, but the type or kind of the electrolyte is not limited in the present disclosure.

The cylindrical can 20 may be made of steel, a steel alloy, aluminum, an aluminum alloy, or an equivalent thereof, but the material thereof is not limited thereto. In addition, a beading part 24 and a crimping part 25 may be in the cylindrical can 20 the cap plate 30 may be centered between the beading part 24 and the crimping part 25 to prevent the electrode assembly 10 from being separated from the cylindrical can 1 to the outside.

The beading part 24 may surround the upper edge of the cap plate 30 and have a shape that is recessed into the cylindrical can 20. The crimping part 25, which is connected to the beading part 24, may surround the upper edge of the cap plate 30 and may have a shape that is bent into the cylindrical can 20.

In the cylindrical can 20, after the electrode assembly 10 is inserted through the open upper end of the cylindrical can 20, the beading part 24 may be provided (e.g., formed) to prevent the electrode assembly 10 from being separated from the cylindrical can 20.

If both the beading part 24 and the crimping part 25 are included in the cylindrical can 20, the crimping part 25 may be above the beading part 24. The crimping part 25 may firmly fix the cap plate 30 by pressing the edge (e.g., the peripheral or circumferential edge) of the cap plate 30.

The electrode assembly 10 may be accommodated with the electrolyte inside the case 20. The electrode assembly 10 may include or be referred to as an electrode group, an electrode body or, a jelly roll. The electrode assembly 10 may include a first electrode plate 11, a second electrode plate 12, and a separator 13 between the first electrode plate 11 and the second electrode plate 12 and may be wound into a cylindrical shape. In some embodiments, a hollow core may be provided at a center (or substantially a center) of the electrode assembly 10 and the hollow core may extend in a vertical longitudinal direction (vertical direction in FIG. 2).

The first electrode plate 11 may include a first base material and a first active material layer on the first base material. A first non-coating portion or a first tab of the first base material on which the first active material layer is not provided may extend outward (e.g., to a lower side), and the first tab may be electrically connected to the positive electrode current collector plate 50. In the present disclosure, the first electrode plate 11 may be referred to as a positive electrode plate or a positive electrode.

The second electrode plate 12 may include a second base material and a second active material layer on the second base material. In the second base material, a second non-coating portion or a second tab on which the second active material layer is not provided may extend outward (e.g., to an upper side), and the second tab may be electrically connected to the negative electrode current collector plate 40. In some embodiments, the first tab and the second tab may extend in opposite directions. In the present disclosure, the second electrode plate 12 may be referred to as a negative electrode plate or a negative electrode.

The first electrode plate 11 may function as the positive electrode. In some embodiments, the first base material may be made of, for example, aluminum foil, and the first active material layer may include, for example, a transition metal oxide. The second electrode plate 12 may function as the negative electrode. In some embodiments, the second base material may be made of, for example, copper foil or nickel foil, and the second active material layer may include, for example, graphite and/or silicon.

The separator 13 may be configured to prevent a short circuit between the first electrode plate 11 and the second electrode plate 12 and allow the movement of lithium ions between the first electrode plate 11 and the second electrode plate 12. In some embodiments, the separator 13 may be on both side surfaces (e.g., opposing side surfaces) of the first electrode plate 11, or the separator 13 may be on both side surfaces (e.g., opposing side surfaces) of the second electrode plate 12.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiaA1-bXbO2-cDc (0.90≤a≤1.8, 0≤b≤0.5, 0≤c≤0.05); LiaMn2-bXbO4-cDc (0.90≤a≤1.8, 0≤b≤0.5, 0≤c≤0.05); LiaNi1-b-cCobXcO2-αDα (0.90≤a≤1.8, 0≤b≤0.5, 0≤c≤0.5, 0≤α≤2); LiaNi1-b-cMnbXcO2-αDα (0.90≤a≤1.8, 0≤b≤0.5, 0≤c≤0.5, 0≤α≤2); LiaNibCocL1dGeO2 (0.90≤a≤1.8, 0≤b≤0.9, 0≤c≤0.5, 0≤d≤0.5, 0≤e≤0.1); LiaNiGbO2 (0.90≤a≤1.8, 0.001≤b≤0.1); LiaCoGbO2 (0.90≤a≤1.8, 0.001≤b≤0.1); LiaMn1-bGbO2 (0.90≤a≤1.8, 0.001≤b≤0.1); LiaMn2GbO4 (0.90≤a≤1.8, 0.001≤b≤0.1); LiaMn1-gGgPO4 (0.90≤a≤1.8, 0≤g≤0.5); Li(3-f)Fe2(PO4)3(0≤f≤2); and LiaFePO4(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx(0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and combinations thereof but is not limited thereto.

The organic material and the inorganic material may be mixed in one coating layer or may be in the form of a coating layer containing an organic material and a coating layer containing an inorganic material that are laminated on each other.

The cap plate 30 may be a circular metal plate and may be coupled to the upper end of the cylindrical can 20. In the state in which the edge of the cap plate 30 is seated on the upper portion of the beading part 24 in the cylindrical can 20, the crimping part 25 may be on the upper end of the cylindrical can 20 to fix the cap plate 30 to the cylindrical can 20. The cap plate 30 may be seated on the beading part 24.

The cap plate 30 may be fixed and electrically connected to each of the negative electrode collector plate 40 and the cylindrical can 20 by one or more welds. Accordingly, in one or more embodiments, the cap plate 30 may have the same polarity as the negative electrode collector plate 40. The cap plate 30 may have a circular plate shape.

In some embodiments, an insulating member may be between the cap plate 30 and the cylindrical can 20. In an embodiment in which the insulating member is installed, the cap plate 30 and the cylindrical can 20 may not be electrically connected and thus may not have the same polarity. In an embodiment in which the insulating member is installed, the cap plate 30 may be neutral, and the cylindrical can 20 have a negative polarity.

In some embodiments, the cap plate 30 may include a cap notch 32 that defines a groove configured to be opened at a set pressure. The cap plate 30 may prevent the cylindrical secondary battery 1 from exploding if an internal pressure of the cylindrical can 20 exceeds a breaking pressure.

The negative electrode current collector plate 40 may be inside the cylindrical can 20 and may have any suitable shape for connecting the cylindrical can 20 to the negative electrode plate.

The negative electrode current collector plate 40 according to embodiments may include a body part 42 in contact with the negative electrode plate, and a connection tab 44 that extends to the outside of the body part 42 and is fixed to the cylindrical can 20. In some embodiments, the negative electrode current collector plate 40 may further include a notch groove configured to break in response to the internal pressure of the cylindrical can 20 increasing.

FIG. 3 illustrates an exploded perspective view of the secondary battery 1 according to embodiments of the present disclosure. As illustrated in FIGS. 2 and 3, the positive electrode current collector plate 50 may be electrically connected to the electrode assembly 10 and may inside the cylindrical can 20. The positive electrode current collector plate 50 may be between the electrode assembly 10 and the inner terminal 60 and may be electrically connected to the electrode assembly 10 and the inner terminal 60.

The positive electrode collector plate 50 may be a circular metal plate having a shape corresponding to a shape of a bottom surface of the electrode assembly 10. A planar size of the positive electrode collector plate 50 may be approximately equal to or less than a size of the bottom surface of the electrode assembly 10. The positive electrode current collector plate 50 may be made of aluminum (Al). The positive electrode current collector plate 50 may be fixed by welding in a state in which a top surface of the positive electrode current collector plate 50 is in contact with the lower portion of the electrode assembly 10. The positive electrode current collector plate 50 may be fixed to the first electrode plate 11 exposed on the lower portion of the electrode assembly 10 and thereby the positive electrode current collector plate 50 may be electrically connected to the first electrode plate 11. Because the bottom surface of the positive electrode current collector plate 50 is fixed by welding in the state of being in contact with the top surface of the inner terminal 60, the positive electrode current collector plate 50 may be fixed and electrically connected to the inner terminal 60. The positive electrode current collector plate 50 may be between the first electrode plate 11 and the inner terminal 60 of the electrode assembly 10 and be electrically connected to serve as a path through which current flows.

The positive electrode current collector plate 50 according to embodiments may include a current collector body 51, which is in contact with and electrically connected to the electrode assembly 10, an inner body 53 inside a spaced hole 54 defined in a center (or substantially a center) of the current collector body 51 and fixed to the inner terminal 60, and a bridge 52 that connects the current collector body 51 to the inner body 53.

The current collector body 51 may have a disk shape and may be inside the cylindrical can 20. The current collector body 51 and the first electrode plate 11 may be fixed to each other by welding. The spaced hole 54, which is a hole, may be inside the current collector body 51, and the inner body 53 may be at the center (or substantially the center) of the spaced hole 54. The inner body 53 may be electrically connected to a central body 62 of the inner terminal 60 by welding. The inner body 53 may be a disk. The inner body 53 and the current collector body 51 may be connected by the bridge 52.

The inner terminal 60 may be electrically connected to the positive electrode current collector plate 50 and may have a connection hole 64. The inner terminal 60 may be electrically connected to the electrode assembly 10 and may include the connection hole 64. The inner terminal 60 according to embodiments may include an edge member 61, the central body 62, a connection body 63, and a connection hole 64.

The edge member 61 may be between the positive electrode current collector plate 50 and the variable connection part 70. The edge member 61 may be a plate extending in an annular (e.g., a ring) shape.

The central body 62 may be inside the connection hole 64 in the center (or substantially the center) of the edge member 61. The central body 62 may have a disk shape and may be made of a conductor material. The central body 62 may be electrically connected to the inner body 53 and the variable body 72.

The inner terminal 60 may include a plurality of connection bodies 63 to connect the edge member 61 to the central body 62. A fluid moving through the spaced hole 54 of the positive electrode current collector plate 50 may be transferred to the variable connection part 70 through the connection hole 64 in the inner terminal 60.

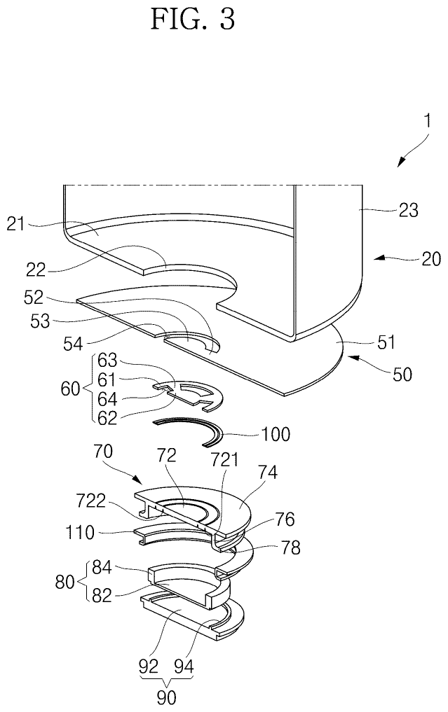

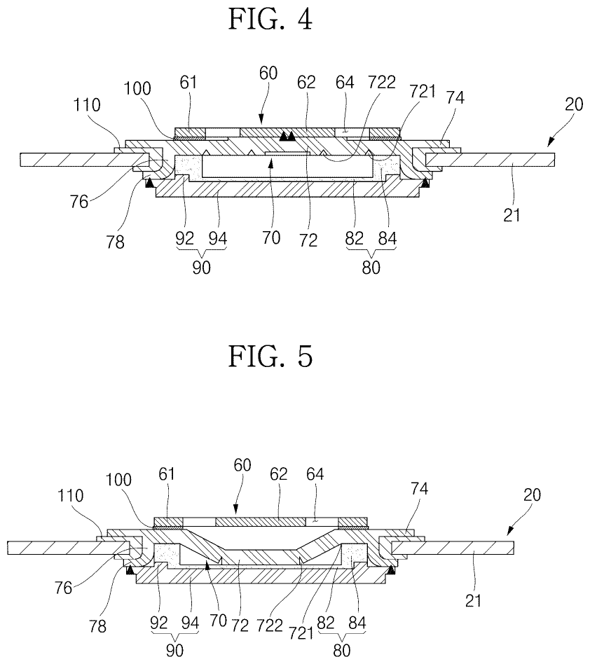

FIG. 4 illustrates a cross-sectional view of a state in which the variable connection part 70 is in contact with an inner terminal 60 according to embodiments, and FIG. 5 illustrates a cross-sectional view of a state in which the variable connection part 70 is spaced apart from the inner terminal 60 according to embodiments. As illustrated in FIGS. 4 and 5, the variable connection part 70 may be fixed to the cylindrical can 20 in a state of being in contact with the inner terminal 60, and in response to the internal pressure of the cylindrical can 20 increasing, the variable connection part 70 may be deformed to become spaced apart from the inner terminal 60 and thereby block the flow of the current. An edge of the variable connection part 70 may be fixed to the cylindrical can 20, and the center (or substantially the center) of the variable connection part 70 may be fixed to be in contact with the inner terminal 60. The variable connection part 70 according to embodiments may include a variable body 72, a fixed body 74, an extension body 76, and a bending body 78.

The variable body 72 may extend from the fixed body 74 and be fixed to the inner terminal 60 and the variable body 72 may be configured to move in a direction away from the inner terminal 60 due to the pressure of the gas passing through the inner terminal 60. The variable body 72 may be fixed to the inner terminal 60 by welding.

A plurality of groove-shaped notches that are configured to induce the deformation of the variable body 72 may be on the variable body 72. The variable body 72 according to embodiments may include a first notch 721 defining a groove along a circumferential direction and a second notch 722 inside (e.g., spaced radially inward from) the first notch 721 to define a groove along the circumferential direction.

In the variable body 72, in response to the internal pressure of the cylindrical can 20 exceeding the breaking pressure, the first notch 721 and the second notch 722 may be broken or bent so that the variable body 72 moves to block the flow of the current, thereby preventing the secondary battery 1 from exploding. That is, in response to an excessive internal pressure occurs inside the cylindrical can 20, the first notch 721 and the second notch 722 may be bent or broken to release the excessive pressure inside the cylindrical can 20 and block the flow of the current from the inner terminal 60 to the terminal cover 90.

The first notch 721 and the second notch 722 of the variable body 72 may be spaced apart from the central portion of the variable body 72 and may both have a ring shape in a planar view. In other embodiments, the first notch 721 and the second notch 722 may have multiple patterns, and the shapes of the first notch 721 and the second notch 722 is limited in the present disclosure.

The fixed body 74 may be inside the cylindrical can 20 and the movement of the fixed body 74 in the cylindrical can 20 may restricted. The fixed body 74 may be along an outer edge of the variable body 72, and the fixed body 74 and the variable body 72 may be connected to each other. The first notch 721 may be at a boundary between the fixed body 74 and the variable body 72. The second notch 722 may be on an outer circumference of a portion of the variable body 72 at which the variable body 72 and the inner terminal 60 are fixed together by welding. The fixed body 74 according to embodiments may include an extension body 76 and a bending body 78.

The extension body 76 may extend from the fixed body 74 to the outside of the cylindrical can 20. The extension body 76 may have a shape that passes through the terminal hole 22 of the base part 21. The extension body 76 may have a cylindrical shape.

The bending body 78 may extend from the extension body 76 and hang on the outside of the cylindrical can 20 and the bending body 78 may be electrically connected to the terminal cover 90. The variable connection part 70 may be made of a conductor material and may be configured to transmit the current received through the inner terminal 60 to the terminal cover 90.

The spacer 80 may be between the variable connection part 70 and the terminal cover 90 and may define an inner space for the variable connection part 70 to move (e.g., be deformed). The spacer 80 may be made of an insulating material. In some embodiments, the spacer 80 may be between the terminal cover 90 and the variable connection part 70 and may include a spacer body 82 and a sidewall member 84 extending from an edge of the spacer body 82 to support the variable connection part 70.

The spacer body 82 may have a disk shape. The spacer body 82 may face the terminal body 92 of the terminal cover 90. The spacer body 82 may be in contact with the terminal body 92.

The sidewall member 84 may be a cylindrical protrusion extending from the edge of the spacer body 82 in a direction (e.g., upward) toward the variable connection part 70. A height of the sidewall member 84 may be based on (e.g., substantially equal to or greater than) a distance along which the variable body 72 of the variable connection part 70 moves.

The terminal cover 90 may be electrically connected to the variable connection part 70 and may be outside the cylindrical can 20. The terminal cover 90 may be made of a conductor material. The terminal cover 90 according to embodiments may include a terminal body 92 and a terminal protrusion 94.

The terminal body 92 may be in contact with the and electrically connected to the variable connection part 70. The terminal body 92 may be outside the cylindrical can 20. Because the outside of the terminal body 92, which is configured to be welded to the busbar, defines a flat surface, a welding area with the busbar may be easily secured or achieved. The terminal body 92 may have various shapes including a flat disk.

The terminal protrusion 94 may include a protrusion protruding from the terminal body 92 toward the spacer 80. The terminal protrusion 94 according to embodiments may protrude in a ring shape and may be engaged with a lower portion of the spacer 80 to restrict the movement of the spacer 80.

The first insulating member 100 may be between the fixed body 74 and the inner terminal 60 and may be made of an insulating material. The first insulating member 100 according to embodiments may have a ring shape. The first insulating member 100 may be between the edge member 61 of the inner terminal 60 and the fixed body 74 of the variable connection part 70. Thus, the flow of the current may be blocked from the edge member 61 to the fixed body 74.

The second insulating member 110 may be between the variable connection part 70 and the cylindrical can 20 and may be made of an insulating material. The second insulating member 110 according to embodiments may be between the variable connection part 70 and the base part 21 in which the terminal hole 22 is defined. Thus, the current flowing along the variable connection part 70 may be blocked from moving to the base part 21 of the cylindrical can 20.

As described above, the secondary battery 1 according to embodiments may have a space between the terminal cover 90 and the variable connection part 70. Thus, in response to the internal pressure of the cylindrical can 20 increasing, the central portion of the variable connection part 70 may move (e.g., swell or otherwise deform) to block the flow of current.

The spacer 80 may define a space at a position at which the central portion of the variable connection part 70 is configured to move. Because the spacer 80 is insulated, the variable connection part 70 may be prevented from being in contact with or being electrically connected to the terminal cover 90.

As illustrated in FIG. 4, in response to the pressure of the cylindrical can 20 being normal, the variable body 72 of the variable connection part 70 may be in contact with the central body 62 of the inner terminal 60 (e.g., due to the weld). Thus, the current of the electrode assembly 10 may be transmitted to the central body 62 of the inner terminal 60 through the inner body 53 of the positive electrode current collector plate 50. The current flowing to the central body 62 may flow to the variable body 72 of the variable connection part 70 to flow to the extension body 76 and the bending body 78 and then flow the terminal cover 90 in contact with the variable connection part 70. Because the terminal cover 90 is welded to the busbar, the current may flow to the busbar.

As illustrated in FIG. 5, in response to the pressure of the cylindrical can 20 increasing, pressure may be transmitted to the variable connection part 70 through the spaced hole 54 of the positive electrode current collector plate 50 and the connection hole 64 of the inner terminal 60 such that the variable body 72 moves downward away from the inner terminal 60 (e.g., the variable body is bent about the first notch 721 and the second notch 722). Because the variable body 72 is bent around the first notch 721 and the second notch 722 of the variable connector 70, the variable body 72 may be spaced apart from the central body 62. Thus, the current to be transmitted to the central body 62 may not flow to the variable body 72, and thus, the electrical connection between the inner terminal 60 and the variable connection part 70 may be blocked.

In the secondary battery 1 according to embodiments, in response to the pressure inside the secondary battery 1 increasing, the supply of the current may be blocked due to the deformation of the variable connector 70 to reduce a risk of fire. In some embodiments, because the terminal cover 90 of the present disclosure has a flat surface, the contact area between the busbar and the terminal cover 90 may increase to ensure a stable welding area.

The battery according to the above-described embodiments may be used to manufacture a battery pack.

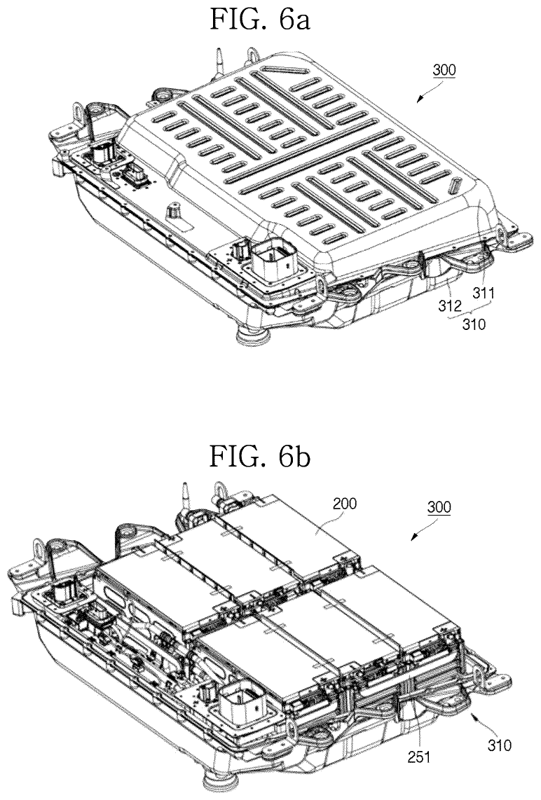

FIGS. 6A and 6B illustrate perspective views of a battery pack including the secondary battery 1 according to embodiments of the present disclosure. Referring to FIGS. 6A and 6B, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

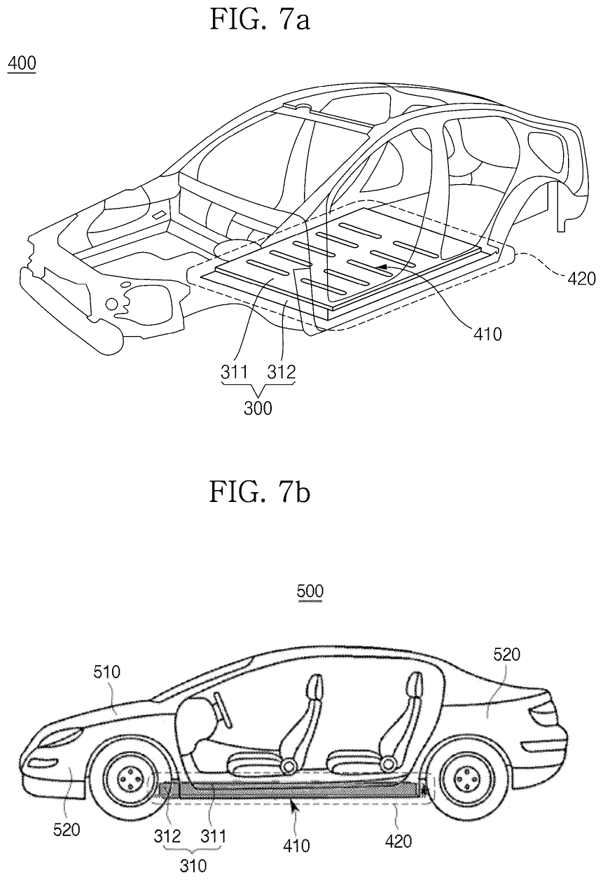

FIGS. 7A and 7B illustrate perspective and side views of vehicles 400 and 500 including the battery pack 300 according to embodiments. In FIG. 7A, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 7B, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

According to the present disclosure, if the pressure inside the secondary battery increases, the supply of the current may be blocked due to the deformation of the variable connection part to reduce the risk of the fire.

According to the present disclosure, because the terminal cover has a the flat surface, the contact area between the busbar and the terminal cover may increase to secure the stable welding area.

However, the effects achievable through the present invention are not limited to those described above, and other technical effects not mentioned can be clearly understood by those skilled in the art from the description of the invention provided below.

As described above, while the embodiments of the present disclosure have been described with reference to the specific embodiments, it will be apparent to those skilled in the art that various changes and modifications may be made without departing from the spirit and scope of the invention as defined in the following claims.

1 what is claimed is:

1. A secondary battery comprising:
a cylindrical can accommodating an electrode assembly;
a positive electrode current collector plate electrically connected to the electrode assembly and inside the cylindrical can;
an inner terminal electrically connected to the positive electrode current collector plate, the inner terminal comprising a connection hole;
a variable connection part fixed to the cylindrical can, the variable connection part being in contact with the inner terminal and spaced apart from the inner terminal and being configured to block a flow of current in response to an internal pressure of the cylindrical can increasing;
a terminal cover electrically connected to the variable connection part, the terminal cover being outside the cylindrical can; and
a spacer between the variable connection part and the terminal cover, the spacer being configured to define an inner space for movement of the variable connection part.

2. The secondary battery as claimed in claim 1, wherein an edge of the variable connection part is fixed to the cylindrical can, and wherein a center of the variable connection part is in contact with the inner terminal.

3. The secondary battery as claimed in claim 1, wherein the variable connection part comprises:
a fixed body inside the cylindrical can, wherein movement of the fixed body is restricted; and
a variable body extending from the fixed body and fixed to the inner terminal, the variable body being configured to move in a direction away from the inner terminal in response to a pressure of a gas passing through the inner terminal.

4. The secondary battery as claimed in claim 3, wherein the variable connection part further comprises:
an extension body extending to the outside of the cylindrical can from the fixed body; and
a bending body extending from the extension body, the bending body being hung on the outside of the cylindrical can and electrically connected to the terminal cover.

5. The secondary battery as claimed in claim 3, further comprising a first insulating member between the fixed body and the inner terminal, the first insulating member comprising an insulating material.

6. The secondary battery as claimed in claim 5, further comprising a second insulating member between the variable connection part and the cylindrical can, the second insulating member comprising an insulating material.

7. The secondary battery as claimed in claim 3, wherein the variable body is fixed to the inner terminal by at least one weld, and
wherein the variable body further comprises a notch having a groove shape, the notch being configured to induce deformation of the variable body.

8. The secondary battery as claimed in claim 7, further comprising:
a first notch having a groove along a circumferential direction of the first notch; and
a second notch inside the first notch and having a groove along a circumferential direction of the second notch.

9. The secondary battery as claimed in claim 4, wherein the terminal cover comprises:
a terminal body in contact with and electrically connected to the variable connection part; and
a terminal protrusion comprising a protrusion protruding from the terminal body to the spacer.

10. The secondary battery as claimed in claim 1, wherein the spacer comprises an insulating material.

11. The secondary battery as claimed in claim 1, wherein the spacer comprises:
a spacer body between the terminal cover and the variable connection part, the spacer body comprising an insulating material; and
a sidewall member extending from an edge of the spacer body, the sidewall member being configured to support the variable connection part.

12. A secondary battery comprising:
a cylindrical can accommodating an electrode assembly;
an inner terminal electrically connected to the electrode assembly and comprising a connection hole;
a variable connection part fixed to the cylindrical can and in contact with the inner terminal, the variable connection part being configured to block a flow of current in response to an internal pressure of the cylindrical can increasing; and
a terminal cover electrically connected to the variable connection part and outside the cylindrical can,
wherein the variable connection part comprises:
a fixed body inside the cylindrical can, wherein movement of the fixed body is restricted; and
a variable body extending from the fixed body and fixed to the inner terminal, the variable body being configured to move in a direction away from the inner terminal in response to a pressure of a gas passing through the inner terminal.

13. The secondary battery as claimed in claim 12, further comprising a positive electrode current collector plate between the electrode assembly and the inner terminal and electrically connected to the electrode assembly and the inner terminal.

14. The secondary battery as claimed in claim 13, wherein the positive electrode current collector plate comprises:
a current collector body in contact with and electrically connected to the electrode assembly;
an inner body inside a spaced hole at a center of the current collector body and fixed to the inner terminal; and
a bridge configured to connect the current collector body to the inner body.

15. The secondary battery as claimed in claim 14, wherein the inner terminal comprises:
an edge member between the positive electrode current collector plate and the variable connection part;
a central body inside a connection hole at a center of the edge member and electrically connected to the inner body and the variable body; and
a connection body configured to connect the edge member to the central body.

16. The secondary battery as claimed in claim 12, wherein the variable body comprises a plurality of notches each having a groove shape, the plurality of notches being configured to induce deformation of the variable body.

17. The secondary battery as claimed in claim 12, further comprising a spacer between the variable connection part and the terminal cover, the spacer comprising an insulating material and being configured to define an inner space for movement of the variable connection part.
